(19) United States
(12) Patent Application Publication
(10) Pub. No.: US 2007/0110880 A1
(43) Pub. Date: May 17, 2007

(54) Hypoallergenic animal food

(75) Inventors: Carla Randall Thomas, Ballwin, MO (US); Amy Joy Randall, High Point, NC (US)

Correspondence Address: Robert Steve Thomas, Esq., 849 Kiefer Trails Drive, Ballwin, MO, 63021, US

(73) Assignee: Serenegy, LLC, Ballwin, MO (US)

(21) Appl. No.: 11/592,024

(22) Filed: Nov. 1, 2006

Related U.S. Application Data
(60) Provisional application No. 60/732,231, filed on Nov. 1, 2005.

(51) Int. Cl. A23K 1/00

(52) U.S. Cl. 426/623

(57) ABSTRACT

The present invention provides hypoallergenic food products for animals, and in particular, to hypoallergenic pet treats for domestic pets such as dogs and cats and the like. Also provided are methods of providing hypoallergenic nutrition to animals and to processes for the manufacture of hypoallergenic animal foods.

### CROSS REFERENCE TO RELATED PATENTS AND PATENT APPLICATIONS

This application is related to and claims the priority benefit of U.S. patent application Ser. No. 60/732,231 filed Nov. 1, 2005, which is incorporated by reference herein in its entirety.

### BACKGROUND OF THE INVENTION

(1) Field of the Invention

The present invention relates to hypoallergenic food products for animals, and in particular, to hypoallergenic pet treats for animals such as dogs and cats and the like.

(2) Description of the Related Art

Food allergies, or food hypersensitivities, commonly afflict household pets, such as dogs and cats. While most pets' reaction to allergenic food is not typically fatal, the reactions can still be quite severe. Domestic pets give their owners pleasure and often come to be regarded as family members. Accordingly, pet owners also experience distress when their pets develop food allergies.

For example, food allergies can cause a pet to exhibit symptoms such as excessive itching and scratching, chronic diarrhea, vomiting, bronchoconstriction, anaphylaxis, weight loss, malabsorption of nutrients, abdominal pain and lethargy. An estimated 15% of all dogs in the United States suffer from allergies of some type, and about 10% of those arise from food-based hypersensitivities. Between 5 and 10% of cats have food-based hypersensitivities. The foods that typically cause hypersensitivity reactions in dogs are dairy products, beef, chicken, pork, lamb, eggs, corn, wheat, rice, peanuts and soy. The same foods also cause hypersensitivity reactions in cats with fish being predominate over the rest.

The diagnosis of food hypersensitivity is a particularly difficult problem and consumes an inordinate amount of veterinarians' time. Despite development of sophisticated immunoassay techniques such as radioallergosorbent tests (RAST), radioimmunoassay, and enzyme-linked immunosorbent assays (ELISA), the most reliable method of diagnosing food allergies is to conduct food allergy trials.

Food allergy trials are typically performed by replacing the pet's usual food with food to which the pet has never been exposed and then, monitoring the pet for an allergenic response. All pets that share toys and water must also follow the food trial to prevent cross contamination. Food allergy trials are very long and time consuming for both the veterinarian and owners. The pets consume a novel diet for a minimum of 6 weeks, ideally 8-12 weeks before protein challenges begin. When a pet's symptoms subside, a single protein at a time, such as chicken, is re-introduced into the diet. If the symptoms recur within 2 weeks, then the pet returns to the restrictive diet until symptoms subside before another protein may be challenged. This continues until the particular food hypersensivities are identified.

Unfortunately, the typical foods used for pet food allergy trials are very restrictive in their protein and carbohydrates or contain hydrolyzed proteins, which reduce the overall availability of compatible treats. Another problem with current mass-produced animal foods is the possibility of allergen contamination. Many commercial manufacturers utilize machines to produce treats, which are not solely dedicated to one particular protein/carbohydrate type. These machines are often contaminated with allergic components from previously run products. Therefore, veterinarians usually forego the risk of jeopardizing the lengthy and expensive food trial and simply will not allow the pets to have any treats during the trial.

Although, some hypoallergenic animal treats have been marketed, palatability issues need to be addressed with regard to many of these treats. Many of the available treats have low palatability and many animals refuse to eat them. For example, some commercially-available dog treats contain canola oil, which is known to be detrimental in terms of palatability. Likewise, some commercially-available dog treats contain citric acid/citrate, which can cause stomach upset due to its acidic nature.

Due to these limitations, there are currently few treats available that veterinarians can guarantee will not compromise a food allergy trial, yet are still palatable. This can cause distress to owners who desire to give their pets a particular quality of life or for pets' who are still in training and cannot receive a food reward. With no suitable treats available to owners during this time-consuming process, it increases the risk of cheating on the diet, thus invalidating the trial and frustrating both owner and veterinarian.

Therefore, the present invention provides an improved hypoallergenic food and/or treats for animals, and in particular, for domestic pets. Likewise, the present invention provides a treat that will not compromise the food trial. The present invention also provides a hypoallergenic treat that is highly palatable to an animal without compromising the hypoallergenicity of the treat. The present invention also provides a method for producing hypoallergenic pet treats. Finally, the present invention provides a way to improve the clinical effectiveness of food trials in pets by helping to maintain the pets' normal quality of life for the duration of the test and helping to eliminate the chance of compromising the trial if owners use treats that have allergic components.

### SUMMARY

Briefly, therefore, the present invention is directed to a hypoallergenic animal food comprising a lipid, an agglomerating agent, and a carbohydrate.

The present invention also provides a method of providing nutrition to an animal comprising a novel hypoallergenic animal food comprising a lipid, an agglomerating agent, and a carbohydrate.

The present invention also provides an article of manufacture comprising a package containing a novel hypoallergenic animal food comprising a lipid, an agglomerating agent, and a carbohydrate.

### BRIEF DESCRIPTION OF THE DRAWINGS

FIG. 1 depicts a flow chart describing one embodiment for the production of hypoallergenic animal food of the present invention.

### DETAILED DESCRIPTION OF THE INVENTION

Reference now will be made in detail to the embodiments of the invention, one or more examples of which are set forth below. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used on another embodiment to yield a still further embodiment. Thus, it is intended that the present invention cover such modifications and variations as come within the scope of the appended claims and their equivalents. It is to be understood by one of ordinary skill in the art that the present discussion is a description of exemplary embodiments only, and is not intended as limiting the broader aspects of the present invention.

In accordance with the present invention, it has been discovered that the successful treatment of food hypersensitivity in an animal ideally includes a food that is intrinsically hypoallergenic. Moreover, the palatable animal food provided by the present invention is less likely to compromise a food allergy trial while maintaining the quality of life people expect for their companions. The present invention addresses these needs through providing a palatable animal food comprising protein, carbohydrate and lipids, etc., that are considered hypoallergenic in an animals' diet.

The compositions used herein are, in a preferred embodiment, animal food compositions. As used herein, the term “food” means any composition that is intended for ingestion by an animal. These will advantageously include foods intended to supply necessary dietary requirements, as well as treats (e.g., dog biscuits) or other food supplements. Optionally, the composition herein may be a pet food composition such as a dry composition (e.g., kibble), semi-moist composition, wet composition, or any mixture thereof. Alternatively, the composition is a supplement, such as gravy, drinking fluid, yogurt, powder, suspension, chew, or any other delivery form.

As used herein, the term “intended animal” refer to the animal(s) to which the food is administered.

As used herein, the term “hypoallergenic” refers to a reduced allergic reaction.

As used herein, the term “hypoallergenic animal food” refers to a composition that when fed to an animal at customary levels does not produce a clinically discernible allergic reaction.

As used herein, the term “allergy” refers to a disease state characterized by hypersensitivity responses to allergens, and in some embodiments, are mediated by IgE antibodies.

As used herein, the term “allergen” refers to an antigen that may elicit a hypersensitivity response.

As used herein, the term “antigen” refers to a substance capable of eliciting an immune response in an animal.

As used herein, the term “animal” refers to any animal, including humans, dogs, cats, horses, mice, rats, ferrets, zoological animals, companion animals, and the like.

As used herein, the term “hypersensitivity” refers to an exaggerated, sometimes deleterious, response of the immune system to an antigen.

As used herein, the terms “food hypersensitivity” refer to an allergy or other immune-mediated adverse reaction to a food fed to an animal.

In some embodiments, the hypoallergenic food is a “nutritionally complete” animal food. For example, the hypoallergenic food may be suitable as the exclusive of food intake for the animal by having nutrients to sustain life in proper amounts and proportion based on recommendations of recognized authorities in the field of animal nutrition. One of skill in the art will understand how to prepare a nutritionally complete animal food.

However, in other embodiments, the hypoallergenic animal food is not a nutritionally complete animal food and therefore, may be in the form of a treat that supplements the animal's regular food.

In one embodiment, the present invention provides a palatable animal food while maintaining hypoallergenicity by combining a carbohydrate with an edible lipid, agglomerating agent and preservatives.

In preferred embodiments, the present invention provides a palatable animal food while maintaining hypoallergenicity by providing animal food comprising only non-allergenic proteins. For example, in some embodiments the animal food is a dog food and/or a dog treat that is free of allergenic proteins such as beef, dairy products, chicken, pork, lamb, eggs, corn, wheat, rice, peanuts, soy, carrots and apples. Likewise, in other embodiments, when the animal food is a cat food and/or a cat treat, the food or treat is free of allergenic proteins such as fish, beef, dairy products, chicken, pork, lamb, eggs, corn, wheat, rice, peanuts, soy, carrots and apples.

In preferred embodiments, the present invention provides a palatable animal food while maintaining hypoallergenicity by providing animal food comprising only non-allergenic lipids. For example, some embodiments the animal food is a dog food and/or a dog treat that is free of allergenic lipids such as beef fat, chicken fat, pork fat, lamb fat, corn oil, rice oil, peanut oil and soybean oil. Likewise, in other embodiments, when the animal food is a cat food and/or a cat treat, the food or treat is free of allergenic lipids such as fish oil, beef fat, chicken fat, pork fat, lamb fat, corn oil, rice oil, peanut oil and soybean oil.

In preferred embodiments, the present invention provides a palatable animal food while maintaining hypoallergenicity by providing animal food comprising only non-allergenic carbohydrates. For example, some embodiments the animal food is a dog food and/or a dog treat that is free of allergenic carbohydrates such as corn, corn starch, wheat, eggs, dairy products, rice, peanuts, soy, beef, chicken, pork, lamb, carrots and apples. Likewise, in other embodiments, when the animal food is a cat food and/or a cat treat, the food or treat is free of allergenic carbohydrates such as fish, beef, dairy products, chicken, pork, lamb, eggs, corn, wheat, rice, peanuts, soy, carrots and apples.

In preferred embodiments, the present invention provides a palatable animal food while maintaining hypoallergenicity by providing animal food comprising only non-allergenic preservatives. For example, some embodiments the animal food is a dog food and/or a dog treat that is free of allergenic preservativess such as tocopherols in soybean oil, peanut oil, corn oil, rice bran, or encapsulated in any gel capsule containing gelatin usually from beef, chicken or pork skin, connective tissue or bones. Other preservatives such as rosemary extract are suspended in soybean oil or corn oil. Likewise, in other embodiments, when the animal food is a cat food and/or a cat treat, the food or treat is free of allergenic preservatives such as soybean oil tocopherols, rice bran, and corn oil or in capsules made from gelatin derived from beef, chicken or pork skin, connective tissue, or bones.

In preferred embodiments, the present invention provides a palatable animal food while maintaining hypoallergenicity by providing animal food comprising only non-allergenic agglomerating agents. For example, some embodiments the animal food is a dog food and/or a dog treat that is free of allergenic agglomerating agents such as eggs, milk, dairy products, pectin and corn starch. Likewise, in other embodiments, when the animal food is a cat food and/or a cat treat, the food or treat is free of allergenic agglomerating agentss such as eggs, milk, dairy products, pectin and corn starch.

In still other embodiments, the hypoallergenic animal food is preferably free of citric acid and/or canola oil because of the potential for stomach upset and unpalatability.

In some embodiments, the “hypoallergenic animal food” is fed to any animal and includes nutritionally complete animal feeds and animal treats, which are not nutritionally complete. Preferably, the animal is zoological or pet animal, and it is particularly preferred that the animal is a domestic companion animal such as a dog or cat.

In other embodiments, the present invention provides a process for preparing hypoallergenic animal foods comprising mixing hypoallergenic proteins with a hypoallergenic lipid such as olive oil or duck fat to permit preparation of the animal food from commercially-used extruders, rotary presses, molders or sheeters followed by heating the food.

To monitor the successful hypoallergenicity of the animal foods of the present invention one can observe the animal over time after consumption of the hypoallergenic animal food. For example, one of skill in the art will understand how to monitor food-based hypersensitivities by evaluating any development of, or reduction in, physical manifestations such as skin lesions, pustules, pyodermas, skin infections, and the like. For example, one may follow the teachings of U.S. published application No. 20030072786.

Suitable edible carbohydrates, lipids and proteins for use in the present invention can vary widely and are well known to those skilled in the art of making animal foods as long as each component is hypoallergenic in the intended animal. Selection of one or more of the ingredients described herein can be a matter of formulation design or consumer and end-user preferences. For purposes of expediency, several ingredients that are suitable for use with methods and compositions of the present invention are described in further detail below. However, the present invention should not be construed as being limited to any one of the specific ingredients listed herein, since one of skill in the art will readily understand that many suitable ingredients other than the ones described herein could be used in addition to or in lieu thereof, provided the ingredient is hypoallergenic in the intended animal.

One component of the methods and compositions of the present invention is one or more carbohydrates. As used herein, the term “carbohydrate” or “carbohydrates” refers to both simple carbohydrates (i.e., monosaccharide and disaccharides) and complex carbohydrates (i.e., polysaccharides).

The hypoallergenic animal food of the present invention encompasses any of carbohydrates that may be naturally-occurring, synthetic, or developed through the genetic manipulation of organisms, whether such new is now known or later developed as long as the carbohydrate is hypoallergenic for the intended animal. For example, carbohydrates that are suitable for use with the methods and compositions of the present invention can include, but are not limited to, one or more hydrolyzed, intact, naturally and/or chemically modified starchesd from sweet peas, potato, sorghum, alfalfa, cassava, yucca, arrowroot, sage and oat; sugars such as glucose, fructose, dextrose, polydextrose, galactose, sucrose, and maltose; sugar alcohols such as sorbitol, mannitol and xylitol; syrups such as maltitol, erythritol; fructooligosaccharides; and mixtures thereof. Maltodextrins are polysaccharides obtained from the acid or enzyme hydrolysis of starches such as corn or rice. Others carbohydrates include hydrolyzed or chemically modified starchesd from barley, corn, wheat, rice, corn syrup, rice syrup and high fructose corn syrup; maltodextrins and lactose.

Suitable carbohydrates can also be quinoa, Teff, oat bran, amaranth, flaxseed, millet, rye, beans (e.g., green, kidney, pinto, navy, and black eye), sweet potato, and mushroom.

Commercial sources for the carbohydrates listed above are readily available and known to one practicing the art. For example, Fructose is available from A. E. Staley in Decatur, Ill. Maltodextrin, hydrolyzed corn starch is available from American Maize-Products Company in Hammond, Ind. Sucrose is available from Domino® Sugar Corp. in New York, N.Y. Potato flour is available from Fine Potato Flour Idaho Pacific Corporation® Ririe, Id. Potato starch flour is available from World Flower Potato Starch Meelunie, Amsterdam-Holland. Oat flour, millet, erythritol, and polydextrose are available from Honeyville Grain, Inc., Rancho Cucamonga, Calif.

In addition to the carbohydrates described above, the animal food described herein can also contain artificial sweeteners, e.g., saccharides, aspartamine, aspartame, erythritol and/or sorbitol. Such artificial sweeteners can be desirable if the animal food is intended for an overweight animal, or an animal with diabetes that is prone to hyperglycemia. The hypoallergenic animal foods of the present invention encompasses any of artificial sweeteners that may be naturally-occurring, synthetic, or developed through the genetic manipulation of organisms, whether such new is now known or later developed.

The hypoallergenic animal food of the present invention may also include a protein that may be naturally-occurring, synthetic, chemically modified, or developed through the genetic manipulation of organisms, whether such new is now known or later developed as long as the protein is hypoallergenic for the intended animal.

As used herein, the term “protein” or “proteins” refers to organic compounds that comprise amino acids joined by peptide bonds.

For example, proteins that are suitable for use with the methods and compositions of the present invention can include, but are not limited to, any suitable hypoallergenic protein utilized in animal foods including pea protein, potato protein, oat protein, sorghum protein, vegetable protein excluding carrots, fowl including duck, goose, swan, dove, quail, pheasant, ostrich, poussin, guinea fowl, and squab; a mammal such as goat, llama, emu, venison, antelope, caribou, elk, moose, rabbit, kangaroo, goat, squirrel, possum, bear, raccoon, boar, buffalo, yak; fish such as white fish ( e.g., cod, whiting, haddock, and surimi), catfish, herring, and salmon; seafood such as shrimp, crab, squid, conch, crayfish, lobster, scallops, clams, and oysters, insects (e.g., ants, worms, grasshoppers, beetles, cicadas, crickets and eggs and larvae thereof, amphibians (e.g., salamanders, newts, toads, frogs, and eggs thereof ) and reptiles (e.g., snakes, lizards, alligators, iguanas, crocodiles, turtles and eggs thereof.

Proteins that are suitable for use with the methods and compositions of the present invention can also include hydrolyzed proteins. See U.S. Pat. Nos. 6,783,792 and 6,403,142 (assigned to Ralston Purina Company. See also, U.S. published application Nos. 20030035882, 20030059517, and 20030072786.

As used herein, the term “hydrolyzed proteins” or “protein hydrolysates” means protein, which has been processed or treated in a manner intended to break one or more peptide (amide) bonds. Such hydrolyzed peptide fragments and free amino acids are more easily digested and are hypoallergenic for the intended animal. The breakage of amide bonds may occur unintentionally or incidentally during manufacture, for example, due to heating or shear. Thus, one embodiment of the present invention includes proteins with an average molecular weight below 18 kD. Another embodiment of the present invention includes proteins with an average molecular weight of around 12 kD, and with less than 20% of the protein component on a weight basis having a molecular weight greater than 20 kD.

As used herein, the term “Dalton” conforms to common scientific usage to refer to a single gram atomic weight; thus a kiloDalton, abbreviated kD, is a kilogram atomic weight. As used herein, the terms “average molecular weight” conforms to common scientific usage in referring to an average molecular weight calculated as the mass-weighted average of the molecular weights of the components of a mixture.

In yet another embodiment, the present invention includes proteins with an average molecular weight below 4.5 kD, and even further preferred, below 2 kD. In yet other embodiments, the present invention includes 95% to 100% of the proteins having molecular weights ranging from about 1.1 kD to about 4.5 kD.

Suitable protein hydrolysates include, but are not limited to, soy protein hydrolysate, corn protein hydrolysate, casein protein hydrolysate, whey protein hydrolysate, rice protein hydrolysate, potato protein hydrolysate, fish protein hydrolysate, egg albumen hydrolysate, gelatin protein hydrolysate, animal protein hydrolysates, vegetable protein hydrolysates, milk protein hydrolysate, lactalbumen hydrolysate, beef collagen hydrolysate, caseinate hydrolysate (e.g., sodium caseinate, sodium calcium caseinate, calcium caseinate, potassium caseinate), and mixtures thereof.

In some embodiments, the protein may also be provided in the form of free amino acids. One or more free amino acids may be added to the animal food in addition to or as a substitute for the protein component. Examples of suitable free amino acids include, but are not limited to, histidine, isoleucine, leucine, lysine, methionine, cysteine, phenylalanine, tyrosine, threonine, tryptophan, valine, alanine, arginine, asparagine, aspartic acid, glutamic acid, glutamine, glycine, proline, serine, carnitine, taurine and mixtures thereof. In other embodiments, small amino acid peptides may be included as the protein of the present invention. Such small amino acid peptides may be naturally occurring or synthesized.

In other aspects of the present invention, the protein component includes one or more of, but is not limited to, meat selected from a fowl including duck, goose, swan, dove, quail, pheasant, ostrich, poussin, guinea fowl, and squab; a mammal such as venison, antelope, caribou, elk, moose, rabbit, kangaroo, goat, squirrel, possum, bear, raccoon, boar, and buffalo, yak and fish such as white fish (e.g., cod, whiting, haddock, and surimi), catfish, herring, and salmon; seafood such as shrimp, crab, squid, conch, crayfish, lobster, scallops, clams, and oysters, insects (e.g., ants, worms, grasshoppers, beetles, cicadas, crickets and eggs and larvae thereof), amphibians (e.g., salamanders, newts, toads, frogs, eggs thereof) and reptiles (e.g. snakes, lizards, alligators, crocodiles, turtles, and eggs thereof.).

Another component of the methods and compositions of the present invention is one or more lipids. As used herein, the term “lipid” or “lipids” refers to fatty or oily organic compounds. The term “lipid” encompasses all fatty acid-type compounds. Lipids can be classified as either saturated, polyunsaturated, or monounsaturated. Lipids that are suitable for use with the present invention are those lipids, which are hypoallergenic for the intended animal.

Lipids suitable for use with the methods and compositions of the present invention may be naturally-occurring, synthetic, chemically modified or developed through genetic manipulation of organisms, whether such new is now known or later developed as long as the lipid is hypoallergenic for the intended animal.

Sources of lipids that are suitable for use with the methods and compositions of the present invention include, but are not limited to, coconut oil, fish oil ((e.g., white fish, salmon, catfish, and herring) menhaden oil, sardine oil), nut oils (e.g., hazelnut oil, walnut oil, brazil nut oil, chestnut oil, macadamia oil), pumpkin seed oil, sesame seed oil, safflower oil, evening primrose oil, grape seed oil, rapeseed oil, olive oil, flaxseed (linseed) oil, cottonseed oil, high oleic safflower oil, palm stearin, MCT oil (medium chain triglyceride), sunflower oil, high oleic sunflower oil, palm oil, palm olein, palm kernel oil, microbial oils such as fungal and algal oils, and mixtures thereof.

In certain embodiments, the lipid can be any fowl, mammal or plant lipid that is hypoallergenic in the intended animal. For example, the lipid can be almond butter, almond, tree nut, sesame seed, or sunflower oil, goose fat, swan fat, duck fat, guinea fowl fat, poussin fat, llama fat, emu fat, goat fat, rabbit fat, squirrel fat, possum fat, bear fat, buffalo fat, boar fat, venison fat, frog fat, turtle fat, or raccoon fat.

In some embodiments of the present invention, the lipid may comprise at least one of linoleic acid (an omega-3 fatty acid) and/or at least one of linolenic acid (an omega-6 fatty acid). At least one of docosahexonoic acid “DHA” and/or eicosapentaenoic acid “EPA” (omega-3 fatty acids) may be present in certain aspects of the present invention. Likewise, at least one of arachidonic acid “ARA” (an omega-6 fatty acid) may also be present.

Linoleic acid can help maintain skin and coat condition in animals such as dogs and cats. Without enough linoleic acid certain animals may experience dull, dry coat, hair loss, greasy skin and increased susceptibility to skin inflammation. When the skin is already irritated due to an existing allergy, any additional irritant such as pollen, dust, food sensitivity, bacteria or dampness can trigger intense itching. Therefore, certain fatty acids when present in the methods and compositions of the present invention can have beneficial effects in alleviating allergic symptoms such as itching in animals. Cats also require another omega-6 fatty acid, arachidonic acid, for normal skin and coat health.

Furthermore, having the proper ratio of and sufficient amounts of omega-3 and omega-6 fatty acids can assist with proper brain development and visual acuity. Moreover, ensuring that newborn animals and/or prematurely born animals have sufficient omega-3 and omega-6 fatty acids in their diet can enhance their growth.

Linolenic acid can also act as an anti-inflammatory agent by stimulating the production of certain hormone-like substances called prostaglandins. In addition, sufficient amounts of omega-3 fatty acids in an animal's diet can lower blood pressure, reduce the clotting of blood platelets and therefore, reduce blood clots, and reduce abnormal heart beating (arrhythmia).

Thus, proper ratios and amounts of omega fatty acids in the diet are important in optimal health of an animal.

Suitable sources of oils rich in linoleic acid (i.e., an omega-6 fatty acid) include, but are not limited to, sunflower oil, cottonseed oil, walnut oil, chestnut oil, pumpkin seed oil, sesame oil, safflower oil, evening primrose oil, borage oil, brazil nut oil, animal fat from duck, swan, goose, swan, guinea fowl, rabbit, squirrel, possum, bear, buffalo, boar, venison, turtle or raccoon, and mixtures thereof.

Suitable sources of oils rich in linolenic acid (i.e., an omega-3 fatty acid) include, but are not limited to, linseed oil (or flaxseed oil); walnut oil; fish oils such as salmon, mackerel, halibut, and herring; and mixtures thereof.

Suitable sources of DHA include, but are not limited to, fish oils, such as cod, salmon, menhaden, sardine, tuna and many other fish; brain lipids, animal fats, animal organs, lard, tallow from particular animals (duck, swan, goose, swan, rabbit, squirrel, possum, bear, buffalo, boar, venison, and/or raccoon); and microbial oils such as fungal and algal oils described in detail in U.S. Pat. Nos. 5,347,657; 5,550,156; and 5,658,767.

In certain aspects of the present invention, the hypoallergenic animal food may also contain other ingredients in addition to the carbohydrates, proteins, and lipids, described previously, such as one or more vitamins, minerals, antioxidants, agglomerating agents, fibers, flavoring agents, buffering agents, coloring agents, preservatives, emulsifiers, and other dietary supplements, and mixtures thereof.

The agglomerating agents suitable for use with the methods and compositions of the present invention may be naturally-occurring, synthetic, chemically modified or developed through genetic manipulation of organisms, whether such new is now known or later developed as long as the lipid is hypoallergenic for the intended animal.

As used herein, the terms “agglomerating agent” refers to a composition used to effect agglomeration of other ingredients. The methods and compositions of the present invention may optionally include one or more agglomerating agents, including, but not limited to honey, molasses, sugar, maple syrup, fruit, fruit juices or pulps or pulp fibers (except apple) such as those from pineapple, lemon, grapefruit, orange, lime, grape, tomato, kiwi, mango, avocado, watermelon, honeydew melon, cantaloupe, plum, peach, pear, apricot, olive, date, raisin, muskidine, vegetable, vegetable juices or pulps or pulp fibers (except carrot) such as sweet pea, beet, mushroom, zucchini, pepper, tomato, eggplant, asparagus, rhubarb, broccoli, cauliflower, squash, cucumber, rutabaga, artichoke, turnip, onion, pumpkin, brussel sprout, cabbage, spinach and various beans including, Vicia, Vigna, Cicer, Pisum, Lathyrus, Lathyrus sativus, Lathyrus tuberosus, Lens, Lablab, Phaseolus, Psophocarpus, Cajanus, Stizolobium, Cyamopsis, Canavalia, Macrotyloma, and Lupinus or Lupin, sorghum, sweet potato and potato, berry juices and pulps, blueberry, raspberry, currant, boysenberry, blackberry, strawberry, gooseberry, cranberry carboxymethylcellulose (CMC), starch and mixtures thereof. In a preferred embodiment, the agglomerating agent is molasses.

The hypoallergenic animal foods described herein may further comprise vitamins and minerals in amounts sufficient to supply the daily nutritional requirements of such pets as cats and dogs, and in some embodiments, the amounts may be selected according to Association of American Feed Control Officials (AAFCO) guidelines. The hypoallergenic animal foods may also contain other ingredients such as antioxidants, emulsifiers, stabilizers, preservatives, fiber, coloring agents, flavoring agents such as sweeteners, and other dietary supplements.

The methods and compositions of the present invention may optionally include one or more of the following vitamins or derivatives thereof, including, but not limited to, biotin, vitamin B₁, thiamin, thiamin pyrophosphate, vitamin B₂, riboflavin, flavin mononucleotide, flavin adenine dinucleotide, pyridoxine hydrochloride, thiamin mononitrate, folic acid, vitamin B₃, niacin, nicotinic acid, nicotinamide, niacinamide, nicotinamide adenine dinucleotide, tryptophan, biotin, pantothenic acid, vitamin B₆, vitamin B₁₂, cobalamin, methylcobalamin, deoxyadenosylcobalamin, cyanocobalamin, calcium pantothenate, pantothenic acid, vitamin C, ascorbic acid, retinol, retinal, retinoic acid, beta-carotene, vitamin D, vitamin D₃, calciferol, cholecalciferol, dihydroxy vitamin D, 1,25-dihydroxycholecalciferol, 7-dehyrdocholesterol, choline, vitamin E, vitamin E acetate, vitamin K, menadione, menaquinone, phylloquinone, naphthoquinone, and mixtures thereof.

The methods and compositions of the present invention may optionally include one or more of the following minerals or derivatives thereof, including, but not limited to, phosphorus, potassium, sulfur, sodium, docusate sodium, chloride, manganese, magnesium, magnesium stearate, magnesium carbonate, magnesium oxide, magnesium hydroxide, magnesium sulfate, copper, cupric sulfate, iodide, boron, zinc, zinc oxide, chromium, molybdenum, iron, carbonyl iron, ferric iron, ferrous fumarate, polysaccharide iron, fluoride, selenium, molybdenum, calcium phosphate or acetate, potassium phosphate, magnesium sulfate or oxide, sodium chloride, potassium chloride or acetate, ferric orthophosphate, alpha-tocopheryl acetate, zinc sulfate or oxide, copper gluconate, chromium chloride or picolonate, potassium iodide, sodium selenate, sodium molybdate, phylloquinone, cyanocobalamin, sodium selenite, copper sulfate, inositol, potassium iodide, cobalt, and mixtures thereof. Non-limiting exemplary derivatives of mineral compounds include salts, alkaline salts, esters and chelates of any mineral compound.

The minerals can be added in the form of salts such as calcium phosphate, calcium glycerol phosphate, sodium citrate, potassium chloride, potassium phosphate, magnesium phosphate, ferrous sulfate, zinc sulfate, cupric sulfate, manganese sulfate, and sodium selenite. Additional vitamins and minerals that can be added are within the knowledge of a person with ordinary skill in the art who can determine the appropriate amount of vitamins and mineral nutrients following the recommendations of the AAFCO.

The methods and compositions of the present invention may optionally include one or more of the following flavoring agents, including, but not limited to, flavored extracts, volatile oils, vanilla or any commercially available flavoring as long as the flavoring agent is hypoallergenic in the intended animal. Examples of useful flavorings include, but are not limited to, carob extract or powder, pure or imitation extracts such as anise, banana, cherry, lemon, orange, peppermint, spearmint, eucalyptus, parsley, pineapple, rum, strawberry, or vanilla; or volatile oils, such as balm, bay, bergamot, cedar wood, cherry, cinnamon, spearmint, eucalyptus, clove, or peppermint; imitation butterscotch, imitation toffee, and mixtures thereof. The amounts of flavoring agent can vary greatly depending upon the flavoring agent used. Selection of the type and amount of flavoring agent is well within the skill of those of ordinary skill in the art. If required, such ordinary skilled artisan can easily determine the amounts needed to achieve the desired taste through routine experimentation.

The methods and compositions of the present invention may optionally include one or more emulsifiers that may be added for stability of the final product. Examples of suitable emulsifiers include, but are not limited to, lecithin (e.g., from egg or soy), and/or mono- and di-glycerides, and mixtures thereof. Other emulsifiers are readily apparent to the skilled artisan and selection of suitable emulsifier(s) will depend, in part, upon the formulation and final product.

The methods and compositions of the present invention may optionally include one or more preservatives that may also be added to the animal food to extend product shelf life. The hypoallergenic food of the present invention encompasses any of preservative that may be naturally-occurring, synthetic, chemically modified, or developed though the genetic manipulation of organisms, whether such new is now known or later developed as long as the preservative is hypoallergenic for the intended animal.

Suitable preservatives include, but are not limited to, sodium propionate, calcium propionate, potassium sorbate, sodium sorbate, ascorbic acid, potassium benzoate, sodium benzoate, EDTA, mixed tocopherols in olive oil, grapefruit seed extract oil, d-alpha tocopherol in olive oil, d-beta tocopherol in olive oil, d-delta tocopherol in olive oil, d-gamma tocopherol in olive oil and rosemary extract. Other preservative components can include, but are not limited to mixed tocopherols in any oil that is hypoallergenic for the intended animal.

The methods and compositions of the present invention may optionally include one or mores of fiber, including, but not limited to, pea hull fiber, oat hull fiber, gum acacia, inulin, Fibersol-2, cellulose, oat bran, psyllium seed husks, guar gum, and polydextrose, fructooligosaccharide (FOS), galactooligosaccharide (GOS), resistant starch, dextran, and xylo-oligosaccharide (XOS) which are not extracted from known plant allergens (e.g., corn, wheat, dairy, carrot, apple, etc.), and mixtures thereof.

The methods and compositions of the present invention may optionally include one or more stabilizers. Suitable stabilizers for use in the methods and compositions of the present invention, include, but are not limited to, gum arabic, gum ghatti, gum karaya, agar, furcellaran, guar gum, gellan gum, locust bean gum, pectin and low methoxyl pectin (not from apple), microcrystalline cellulose, CMC (sodium carboxymethylcellulose), methylcellulose hydroxypropyl methyl cellulose, hydroxypropyl cellulose, DATEM (diacetyl tartaric acid esters of mono- and diglycerides), dextran, carrageenans, and mixtures thereof.

Other palatability enhancing components may include almond paste, spices such as cinnamon, ginger, nutmeg, salt, pepper, cayenne, cumin, horseradish, poppy seed, sesame, chives, borage, sage, dill, mint, chamomile, fennel, mustard, anise, allspice, spearmint, peppermint, eucalyptus, rosemary, thyme, basil, bay, oregano, red pepper, curry, cloves, amaretto, cilantro, paprika, coriander, parsley, celery, cardamom, vanilla, and tarragon and sweet peas.

Buffering agents can include, but are not limited to, sodium bicarbonate, potassium bicarbonate, magnesium hydroxide, magnesium lactate, magnesium glucomate, aluminum hydroxide, aluminum hydroxide/sodium bicarbonate co precipitate. Additional buffering agents include sodium tartarate, sodium acetate, sodium carbonate, sodium polyphosphate, potassium polyphosphate, sodium pyrophosphate, potassium pyrophosphate, disodium hydrogenphosphate, dipotassium hydrogenphosphate, trisodium phosphate, tripotassium phosphate, potassium metaphosphate, magnesium oxide, magnesium hydroxide, magnesium carbonate, magnesium silicate, calcium acetate, calcium glycerophosphate, calcium chloride, calcium hydroxide, calcium lactate, calcium carbonate, calcium bicarbonate, and other calcium salts.

Where it is desired to support animal joint and/or cartilage health, glucosamine sulfate, glucosamine hydrochloride, chondroitin sulfate, methyl-sulfonyl-methane (MSM), and/or Ester-C®, and other ingredients, may be added to the hypoallergenic animal food of the present invention.

The amounts of the aforementioned ingredients that may be added to the hypoallergenic animal food of the present invention are readily known to the skilled artisan and guidance to such amounts can be provided by the AAFCO. Where suitable amounts of ingredients are indicated below in terms of grams/kilogram (“g/kg”), it is meant as grams of ingredient per grams of the hypoallergenic animal food.

For example, carbohydrates can be present in the hypoallergenic animal foods of the present invention in an amount that can range from about 100 g/kg to about 900 g/kg. In other embodiments, the amount of carbohydrate can range from about 200 g/kg to about 800 g/kg. In still other embodiments, the amount of carbohydrate can range from about 300 g/kg to about 750 g/kg. In some embodiments, the amount of carbohydrate that is present in the hypoallergenic animal foods of the present invention can be about 644 g/kg, about 685 g/kg or about 700 g/kg.

Proteins can be present in the hypoallergenic animal foods of the present invention in an amount that can range from about 5 g/kg to about 400 g/kg. In other embodiments, the amount of protein can range from about 13 g/kg to about 300 g/kg. In still other embodiments, the amount of protein can range from about 20 g/kg to about 200 g/kg. In some embodiments, the amount of protein that can be present in the hypoallergenic animal foods of the present invention can be about 34.7 g/kg or about 82.5 g/kg.

Lipids can be present in the hypoallergenic animal foods of the present invention in an amount that can range from about 5 g/kg to about 500 g/kg. In other embodiments, the amount of lipid can range from about 15 g/kg to about 350 g/kg. In still other embodiments, the amount of lipid can range from about 25 g/kg to about 250 g/kg. In some embodiments, the amount of lipid that can be present in the hypoallergenic animal foods of the present invention can be about 100 g/kg or about 174 g/kg.

Agglomerating agents can be present in the hypoallergenic animal foods of the present invention in an amount that can range from about 50 g/kg to about 900 g/kg. In other embodiments, the amount of agglomerating agents can range from about 100 g/kg to about 800 g/kg. In still other embodiments, the amount of agglomerating agents can range from about 200 g/kg to about 700 g/kg. In some embodiments, the amount of agglomerating agents that can be present in the hypoallergenic animal foods of the present invention can be about 400 g/kg or about 450 g/kg.

Preservative agents can be present in the hypoallergenic animal foods of the present invention in an amount that can range from about 20 ppm to about 7000 ppm lipids to protein. In other embodiments, the amount of preservative agents can range from about 50 ppm to about 6000 ppm lipids to protein. In still other embodiments, the amount of preservative agents can range from about 100 ppm to about 4000 ppm. In some embodiments, the amount of preservative agents that can be present in the hypoallergenic animal foods of the present invention can be about 250 ppm tocopherol and about 2000 ppm Roseen™ liquid of lipids to protein. Alternatively, other preservative rosemary extracts can be about 500 ppm of the lipids and 1000 ppm rosemary extract per protein depending concentration of the antioxidant components of the rosemary extraction in comparison to the concentration of potential toxic monoterpenes also extracted. Different methods of extraction result in varying concentrations of both components and need to be calculated before determining concentration to use for the safest and best preservative effect.

If present, glucosamine sulfate, glucosamine hydrochloride, chondroitin sulfate, methyl-sulfonyl-methane (MSM) may be present in the hypoallergenic animal foods of the present invention in an amount that can range from about 1 mg to about 3000 mg per serving of the hypoallergenic animal food (e.g., per treat).

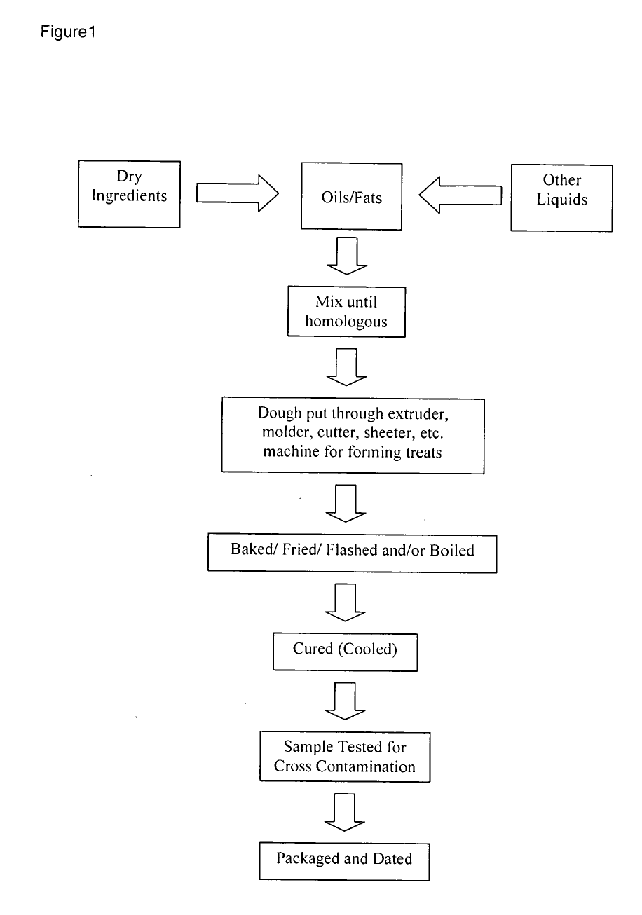

In one embodiment, the manufacturing process for one of the hypoallergenic animal foods of the present invention can be carried out according to the flow chart diagram in FIG. 1. By way of example, however, the manufacturing process may be carried out according to the following description.

Mixing of all components to form a homologous dough can be accomplished by various standard mixing methods: by hand; with a hand beater if it is powerful enough to mix a thick dough; with an industrial mixer with the dough arm or beater at speed 1 or the lowest setting for less than one minute (e.g., Anvil MIX9130 with beater at speed setting 1 for 45 seconds) or with any industrial mixing unit that will evenly combine all ingredients. However, one skilled in the art will understand that the mixing time can vary according to dough consistency and mixer mechanics. For example, suitable time may vary from 30 seconds to 2 minutes, but will usually fall in the 45 second to 1 minute range.

When dough is formed it is then shaped into the desired food shape prior to heating. For a nutritionally complete animal food, the shape may be rounded cylinders, while for animal treats; the shape may be flat squares. Forming can be accomplished by several different methods from manually rolled and cut with cookie cutters or manual strip cutters to the use of industrial machines such as rotary cookie and biscuit presses, sheeting machines with strip cutters, extrusion, or molding machines. The preferable method is sheeting machines with strip cutters, rotary presses or extrusion due to the volume and consistency of dough.

For animal treats, once the dough is formed into the desired shape, the tops of the treat may be stamped with various shapes to indicate the type of treat or any other indicia.

Cooking of the animal food can be performed by several different methods. The food can be fried in the lipid of their components, steamed, boiled, dehydrated, flashed or baked, baking being the preferable method of choice. The baking sheets can be placed in a convection oven at between 300° F. and 375° F. for eight to twelve minutes or baked through a rotator oven for an equivalent baking time or any other method of baking. Depending on temperature, baking time can be adjusted according, as one skilled in the art will understand. The animal food may also be fried in the lipid of mixture. The preferable method involved placing the food in a convection oven at 350° F. for twelve minutes for dough made from Example 1 and eight minutes for Examples 2 and 3 described below. However, one skilled in the art will understand that different ovens such as conventional ovens or older convection ovens with some heat leakage or even just various brands of ovens will bake at various speeds causing the ideal time for baking to vary between ovens. The number of baking sheets in the oven will also vary the optimal baking time. For example the time in conventional ovens may vary between 8 to 15 minutes for one baking sheet, while convection oven times may vary from 6 minutes to 12 minutes depending on number of sheets in oven, age of the oven and brand of oven.

The hypoallergenic animal food is considered cured, i.e. sufficiently cooled, when the core temperature ranges anywhere from 60° F. to 100° F. This may be accomplished in any of the standard baking methods including, but not limited to, slow cooling on racks over one to two hours in well ventilated area, cooling with the use of fans blowing on treats, or proofing ovens. The most preferable method includes the use of fans for efficiency, time and energy.

To maintain the hypoallergenic nature of the present animal food, it is helpful to have physical separation of the measuring tools for different ingredients. Therefore, wherever it is reasonable; have designated items for measuring and storing particular ingredients. For example, each flour should have its' own measuring devise unless whole bags are used at once. Likewise, duck fat should have a separate measuring device from olive oil. Finished animal foods should also have their own designated containers to sit in while awaiting packaging.

Disposable items may be used to prevent equipment contamination. For example, the use of disposable parchment paper can ensure that trays are easily cleansed of oils by degreasers and detergents. In addition, different batches of animal food can be made on separate days to ensure all equipment and cooking area is cleaned, sanitized, and degreased before introducing new ingredients into the environment.

Also, care should be taken to thoroughly clean all utensils and parts of machines that come in contact with the ingredients or dough of food between different batches. See, e.g., Good Manufacturing Practices (GMPs) for the 21^{st} Century—US Food and Drug Administration, CFSAN/Office of Scientific Analysis and Support; Aug. 9, 2004. Cleansing may include, but is not limited to, degreasing agents, detergents, and high temperature water rinsing.

Packaging used for the animal food can be any form available that meets FDA and USDA specifications for food contact. The hypoallergenic animal food can be packaged for distribution and sale as desired using standard equipment known to those of ordinary skill in the art.

For example, the preferable method for treats uses barrier zipper pouches of 3.5 ml plastic that are heat sealable for tamper evident packaging. Specifically, a high clarity zipper pouch that stands upright for display, 3.5 mil plastic thickness (Associated Bag Company, Milwaukee, Wis. 53207-6274, Item number 185-110 and 185-100).

The packaging can be accomplished by any machine that will accurately dispense the weight amount of treats into each bag varying from one ounce to 16 ounces or more, and preferably from four to eleven ounces. Various machines are available for different package forms from boxes to plastic bags. The animal food may also be added and weighed manually.

Any machine available may be used to automatically zip the zipper part of package or close box or tighten lid depending on package type. All treats must be sealed with some form of tamper resistant seal to ensure no contamination from outsides. Heat sealing is the most common method for plastic bags. Shrink-wraps are common for other packaging forms.

All of the hypoallergenic animal food made can be labeled with nutritional information in accordance with AAFCO regulations.

Variations on any of the manufacturing processes described herein are known to or will be readily apparent to those skilled in the art. It is not intended that the invention be limited to any particular process of manufacture. All ingredients of the above embodiments can be mixed together in any order, but for efficiency purposes it is preferable to add the lipid and preservative, which is in a lipid form first, then the agglomerating agent followed by the carbohydrate and proteins.

The following examples describe various embodiments of the present invention. Other embodiments within the scope of the claims herein will be apparent to one skilled in the art from consideration of the specification or practice of the invention as disclosed herein. It is intended that the specification, together with the examples, be considered to be exemplary only, with the scope and spirit of the invention being indicated by the claims which follow the examples. In the examples, all percentages are given on a weight basis unless otherwise indicated.

### EXAMPLE 1

This example illustrates the preparation of one embodiment of the hypoallergenic dog treats of the present invention.

To an industrial mixer's mixing bowl, a lipid was added, followed by a preservative, and then an agglomerating agent, and finally a carbohydrate.

For this particular example, the lipid was an olive oil, and preferably, 100% pure olive oil available as Bertolli Lucca® Classico™ 100% Pure Olive Oil available from Bertolli Lucca®, USA, Englewood Cliffs, N.J. The preservative was E-Oil, specifically 80% mixed tocopherols available from Now® Foods, Bloomington, Ill. The agglomerating agent was molasses, specifically unsulfured Grade A Fancy Golden Molasses available from Groeb Farms, Onsted, Mich. or Light Unsulphured Molasses available from US Foodservice® Columbia, Md. The carbohydrate was oat flour available from Honeyville Grain, Inc. Rancho Cucamonga, Calif. Alternatively, Roseen™ liquid, specifically rosemary extract in sunflower oil available from Kemin® Nutrisurance®, Inc. Des Moines, Iowa may be added as an additional preservative to the lipid at 2000 ppm of the lipid content in this particular case olive oil.

The amounts of each of the components of the composition were: 7.1 ounces olive oil, 10.6 ounces molasses, 40.8 ounces oat flour, and 250 ppm mixed tocopherols/lipids (olive oil).

The composition was then mixed in an Anvil MIX9130 mixer with beater at speed setting 1 for 45 seconds resulting in homogenized dough.

The dough was then rolled out manually on parchment paper and cut into flat square shapes with a strip cutter and then placed on baking sheets.

The baking sheets were then placed in a convection oven at 350° F. for twelve minutes for curing. After cooling for ten minutes, the hypoallergenic dog treats were separated and ready for packaging, and then, consumption.

### EXAMPLE 2

This example illustrates the preparation of one embodiment of the hypoallergenic dog treats of the present invention.

To an industrial mixer's mixing bowl, a lipid was added, followed by a preservative, and then an agglomerating agent, followed by a carbohydrate, and finally a buffering agent.

For this particular example, the lipid was an olive oil, and preferably, 100% pure olive oil available as Bertolli Lucca® Classico™ 100% Pure Olive Oil available from Bertolli Lucca®, USA, Englewood Cliffs, N.J. The preservative was E-Oil, specifically 80% mixed tocopherols available from Now® Foods, Bloomington, Ill. The agglomerating agent was molasses, specifically unsulfured Grade A Fancy Golden Molasses available from Groeb Farms, Onsted, Mich. or Light Unsulphured Molasses available from US Foodservice® Columbia, Md. The carbohydrate was a blend of potato flour and potato starch flour. The potato flour was available as Fine Potato Flour from Idaho Pacific Corporation®, Ririe, Id. The potato starch flour was available as Potato Starch from World Flower Potato Starch, Meelunie, Amsterdam-Holland. The buffering agent was sodium bicarbonate available as “Baking Soda” from Supervalue, Inc., Eden Prairie, Minn. Alternatively, Roseen™ liquid, specifically rosemary extract in sunflower oil available from Kemin® Nutrisurance®, Inc. Des Moines, Iowa may be added as an additional preservative to the lipid at 2000 ppm of the lipid content in this particular case olive oil.

The amounts of each of the components of the composition were: 5.3 ounces olive oil, 10.6 ounces molasses, 19.2 ounces potato starch flour, 13 ounces potato flour, 1 ounce sodium bicarbonate, and 250 ppm mixed tocopherols/lipids (olive oil).

The composition was then mixed in an Anvil MIX9130 mixer with beater at speed setting 1 for 45 seconds resulting in homogenized dough.

The dough was then rolled out with a sheeter onto parchment paper on a baking sheet and cut into flat square shapes with a strip cutter.

The baking sheets were then placed in a convection oven at 350° F. for eight minutes for curing. After cooling for ten additional minutes, the hypoallergenic dog treats were separated and ready for packaging, and then, consumption.

### EXAMPLE 3

This example illustrates the preparation of one embodiment of the hypoallergenic dog treats of the present invention.

To an industrial mixer's mixing bowl, a lipid was added, followed by a preservative, and then an agglomerating agent, followed by a carbohydrate, and finally a buffering agent.

For this particular example, the lipid was duck fat available from D'Artagnan Inc., Newark NJ. The preservative was E-Oil, specifically 80% mixed tocopherols available from Now® Foods, Bloomington, Ill. and Roseen™ liquid, specifically rosemary extract in sunflower oil available from Kemin® Nutrisurance®, Inc. Des Moines, Iowa. The agglomerating agent was molasses, specifically unsulfured Grade A Fancy Golden Molasses available from Groeb Farms, Onsted, Mich. or Light Unsulphured Molasses available from US Foodservice® Columbia, Md. The carbohydrate was a blend of potato flour and potato starch flour. The potato flour was available as Fine Potato Flour from Idaho Pacific Corporation®, Ririe, Id. The potato starch flour was available as Potato Starch from World Flower Potato Starch, Meelunie, Amsterdam-Holland. The buffering agent was sodium bicarbonate available as “Baking Soda” from Supervalue, Inc., Eden Prairie, Minn. Alternatively, rosemary extract available from Liberty Natural Products, Portland, Oreg. used at 500 ppm of lipid and meat content.

The amounts of each of the components of the composition were: 7.2 ounces duck fat with 2000 ppm of Roseen™ liquid, 10.6 ounces molasses, 19.2 ounces potato starch flour, 13 ounces potato flour, 1 ounce sodium bicarbonate, 250 ppm mixed tocopherols/lipid (duck fat).

The composition was then mixed in an Anvil MIX9130 mixer with beater at speed setting 1 for 45 seconds resulting in homogenized dough.

The dough was then rolled out on parchment paper manually and cut into flat square shapes with a strip cutter and then placed on baking sheets.

The baking sheets were then placed in a convection oven at 350° F. for eight minutes for curing. After cooling for ten additional minutes, the hypoallergenic dog treats were separated and ready for packaging, and then, consumption.

### EXAMPLE 4

This example illustrates the amount of base nutrients (proteins, fats and fibers) in one treat (about 5 grams) according to the embodiment described in Example 1 above.

TABLE 1
Nutrient Information

| NUTRIENT | Amount Per 5 grams | |
|---|---|---|
| Crude Protein | 8.0% | Minimum |
| Crude Fat | 17.0% | Minimum |
| Crude Fiber | 1.0% | Maximum |
| Moisture | 11.0% | Maximum |

### EXAMPLE 5

This example illustrates the amount of base nutrients (proteins, fats and fibers) in one treat (about 5 grams) according to the embodiment described in Example 2 above.

TABLE 2
Nutrient Information

| NUTRIENT | Amount Per 5 grams | |
|---|---|---|
| Crude Protein | 2.0% | Minimum |
| Crude Fat | 16.0% | Minimum |
| Crude Fiber | 1.0% | Maximum |
| Moisture | 12.0% | Maximum |

### EXAMPLE 6

This example illustrates the amount of base nutrients (proteins, fats and fibers) in one treat (about 5 grams) according to the embodiment described in Example 3 above.

TABLE 3
Nutrient Information

| NUTRIENT | Amount Per 5 grams | |
|---|---|---|
| Crude Protein | 3.0% | Minimum |
| Crude Fat | 13.0% | Minimum |
| Crude Fiber | 1.0% | Maximum |
| Moisture | 12.0% | Maximum |

### EXAMPLE 7

This example illustrates the clinical effectiveness of the dog treats produced according to Example 3.

A 10 year old male neutered Dachshund presented at the allergy clinic for evaluation of recurrent pyoderma and pruritus, which was characterized as nonseasonal. On physical examination it was determined that he had bacterial dermatitis involving the abdomen and interdigital spaces of all four paws. He was placed on a food trial using Royal Canin® (IVD®) duck and potato diet in conjunction with systemic antibiotics to resolve the pyoderma. The food trial was completely restricted to the Royal Canin® (IVD®) diet in addition to dog treats that were made according to Example 3.

Over the next 4-8 weeks the dog's pruritus resolved as did his secondary pyoderma even though he was receiving the dog treats of Example 3. He did not develop another pyoderma until the owners exposed him to a beef bone. Within 1 week of the exposure he had redeveloped papules and pustules along the ventral abdomen. After the beef bone exposure was ceased, his papules and pustules resolved satisfactorily.

He continued to receive just the dog treats of Example 3 and IVD duck and potato diet and did not redevelop the pyoderma or the pruritis.

Now 11 year old male Dachshund has been maintained on Royal Canin®) (IVD®) duck and potato diet with dog treats made according to Example 3 for over 1 year. Food allergies are completely controlled without any additional dermatologic problems.

### EXAMPLE 8

This example illustrates the clinical effectiveness of the dog treats produced according to Example 2.

A 6 year old male neutered Yorkshire terrier presented to the allergy clinic for evaluation of chronic pruritus involving the back, ears, distal limbs and paws and recurrent bacterial dermatitis. He was placed on Royal Canin® (IVD®) venison and potato diet by his primary veterinarian several months prior to presentation. Since there was only a 50% improvement in his clinical signs, allergy testing was performed with an intradermal test and serum allergy test for atopic dermatitis. In addition to the restricted Royal Canin® (IVD®) venison and potato diet, he was placed on dog treats that were made according to Example 2, which did not cause any worsening of his pruritus.

He was reevaluated approximately 9 weeks later and found that his pruritus was suitably controlled with allergen specific immunotherapy and the Royal Canin® (IVD®) venison and potato diet along with the dog treats made according to Example 2.

He was reevaluated approximately 12 weeks later after he had eaten a peanut butter cookie and had licked the food bowl of another dog (which was being fed a different food). The exposure to different proteins other than the restricted Royal Canin® (IVD(D) venison and potato diet and Example 2 dog treats caused the development of a bacterial dermatitis involving the ventral abdomen and medial aspects of the hind legs.

### EXAMPLE 9

This example illustrates the clinical effectiveness of the dog treats produced according to Example 2.

A 4 year old female Dachshund presented to the allergy clinic for evaluation of possible food allergy (hypersensitivity to eggs), which was diagnosed at less than one year of age. For the past several months she continued to develop pustules and papules on the ventral caudal abdomen which responded to antibiotics, but recurred within 2 weeks of finishing the medication. She was graded 5/10 pruritus on the feet and abdomen. Physical examination with cytology's revealed bacteria and Malassezia sp on the nail beds, interdigital spaces and external ear canals. She was placed on oral antibiotics and topical antifungal and antibacterial medications for a period of 4 weeks. A food trial with Royal Canin® (IVD®) whitefish and potato diet was started for 4-8 weeks in addition to the dog treats made according to Example 2 (as needed).

She was reevaluated 4 weeks later and there was complete resolution of the pruritus and the bacterial and Malassezia dermatitis. The food trial and dog treats from Example 2 were extended and there continued to be a lack of recurrent pyodermas.

She was reevaluated 14 weeks later. She was still eating the Royal Canin® (IVD®) whitefish and potato diet along with the dog treats of Example 2, but within the past 2 weeks the owner fed her a piece of protein bar, which caused the development of a bacterial dermatitis within one week after the exposure. She was started on oral antibiotics, which resolved the lesions. The protein bar's ingredients, which are known to cause hypersensitivity in dogs, include, but are not limited to, soy, wheat and corn starch.

### EXAMPLE 10

This example illustrates the clinical effectiveness of the dog treats produced according to Example 2 and Example 3.

A male 2 year old Boxer presented to the allergy clinic for evaluation of nonseasonal recurrent pyoderma with pruritus and otitis externa. His pruritus involved facial rubbing, scratching at the chin and licking the feet. The owner had noticed significant reduction of his pruritus when they switched his diet to Royal Canin® (IVD®) duck and potato. However, they only kept him on this diet for 3 weeks. Over the past few months his diet was switched several times to lamb and rice based dry food. Within 1-2 weeks of the new diet the Boxer's pruritus would increase and was considered severe. On physical examination he had marked erythema with papules, pustules on the ventral chin and preauricular. He had a moist erythematous dermatitis in the facial folds. Otoscopic examination revealed moderate erythema with mild amount of ceruminous exudates. Secondary pyoderma, Malassezia dermatitis and otitis were also diagnosed. A food trial was started with Royal Canin® (IVD®) duck and potato diet for 4-8 weeks. The diet was completely restricted to the Royal Canin® (IVD®) duck and potato and the dog treats made according to Example 2. He was also started on oral antibacterial medications and topical ear medications.

He was reevaluated 4 weeks later, which revealed significant improvement in his pruritus. There was at least a 50% reduction in his facial and pedal pruritus and erythema. The secondary bacterial and Malassezia dermatitis and otitis resolved with medications. All medications were discontinued and the food trial was continued for another 4 weeks (totally an 8 week trial).

He was reevaluated 8 weeks later, which revealed complete resolution of his pruritus and erythema. The food trial of restricted Royal Canin® (IVD®) duck and potato and dog treats from Example 3 were extended and there continued to be a lack of recurrent pruritus and erythema.

### EXAMPLE 11

This example illustrates the clinical effectiveness of the dog treats produced according to Example 2.

A 5 year old male neutered Soft Coated Wheaten Terrier was presented to the allergy clinic for evaluation of nonseasonal pruritus and recurrent pyoderma which began 2 years prior. The affected areas included dorsal back, distal limbs, feet and face were graded 5/10. Antibiotics and steroids helped to resolve his clinical signs, but returned once the medication was finished. Additional symptoms included mild coughing and sneezing with no head shaking. He was placed on Royal Canin® (IVD®) venison and potato diet, but was not completely restricted.

Over the course of the next year he was diagnosed with food allergies and atopic dermatitis. His current diet remained Royal Canin® (IVD®) venison and potato with dog treats from Example 2. He has continued receiving allergy serum injections (immunotherapy) on a weekly basis to control his atopic dermatitis. With this regimen of restricted food and immunotherapy his pruritus and pyoderma was controlled.

### EXAMPLE 12

This example illustrates the clinical effectiveness of the dog treats produced according to Example 3.

A 6 year old male neutered Jack Russell Terrier brown and white was presented to the allergy clinic for seasonal nonseasonal pruritus involving feet and face. He began on a food trial with Royal Canin® (IVD®) duck and potato diet exclusively which helped reduce his pedal pruritus and erythema during the winter months. In spring and summer he developed some pruritus of the face and feet. After performing an intradermal and serum allergy test, he began immunotherapy which controlled the seasonal flares of pruritus.

The patient was introduced to the dog treats produced from Example 3 with no recurrence of pedal or facial pruritus.

The Terrier has continued on immunotherapy and the restricted Royal Canin® (IVD®) duck and potato diet with the dog treats produced from Example 3 with no recurrence of dermatological symptoms for over 1 year.

### EXAMPLE 13

This example illustrates the clinical effectiveness of the dog treats produced according to Example 2 and 3.

A male neutered chocolate Labrador Retriever was presented to the allergy clinic for nonseasonal pruritus involving feet, hindquarters, auxiliary regions and ears. He had a history of developing secondary Malassezia dermatitis and pododermatitis. A food trial was started with Royal Canin® (IVD®) duck and potato diet for a period of 12 weeks. His pedal pruritus improved and he had decreased recurrence of Malassezia dermatitis, but this did not resolve all his clinical signs. After intradermal and serum allergy tests he was started on immunotherapy.

With weekly immunotherapy injections and a restricted diet with either Royal Canin® (IVD®) rabbit and potato or duck and potato his symptoms have been well controlled. (IVD®) rabbit and potato or duck and potato.

Dog treats produced according to Examples 2 and 3 were included in the patient's diet for over 1 year now with no recurrent Malassezia dermatitis, pododermatitis or pruritus.

### EXAMPLE 14

This example illustrates the clinical effectiveness of the dog treats produced according to Example 2.

A 3 year old female spayed Labrador Retriever was presented to the allergy clinic for recurrent nonseasonal Malassezia pododermatitis, perianal pruritus, and otitis externa. The Labrador was placed on a food trial diet with Royal Canin® (IVD®) venison and potato with complete restriction for a period of 12 weeks. Over this period there was a significant reduction of her pruritus and no recurrence of Malassezia pododermatitis.

Over the past 2 years she has continued to do well with the restricted diet. The dog treats from Example 2 were introduced into the patient's diet over 1 year ago without any development of pruritus or secondary infections.

All references cited in this specification, including without limitation, all papers, publications, patents, patent applications, presentations, texts, reports, manuscripts, brochures, books, internet postings, journal articles, periodicals, and the like, are hereby incorporated by reference into this specification in their entireties.

The discussion of the references herein is intended merely to summarize the assertions made by their authors and no admission is made that any reference constitutes prior art. Applicants reserve the right to challenge the accuracy and pertinence of the cited references.

The recitation of a range of numerical values herein is meant to include each and every number within in the range including the range values cited. Although preferred embodiments of the invention have been described using specific terms, devices, and methods, such description is for illustrative purposes only. The words used are words of description rather than of limitation. It is to be understood that changes and variations may be made by those of ordinary skill in the art without departing from the spirit or the scope of the present invention, which is set forth in the following claims. In addition, it should be understood that aspects of the various embodiments may be interchanged both, in whole or in part.

What is claimed is:

1. A hypoallergenic animal food comprising:
a lipid;
an agglomerating agent that comprises molasses;
a carbohydrate; and
a preservative that comprises d-alpha Tocopherol, wherein the hypoallergenic animal food does not elicit a clinically discernible allergic reaction in the animal.

2. The hypoallergenic animal food according to claim 1, further comprising a preservative.

3. The hypoallergenic animal food according to claim 1, further comprising a protein.

4. The hypoallergenic animal food according to claim 1, further comprising a buffering agent.

5. The hypoallergenic animal food according to claim 5, wherein the buffering agent is sodium bicarbonate.

6. The hypoallergenic animal food according to claim 1, wherein the animal food is nutritionally complete.

7. The hypoallergenic animal food according to claim 1, wherein the animal food is a treat.

8. The hypoallergenic animal food according to claim 1, wherein the animal is free of citric acid.

9. The hypoallergenic animal food according to claim 1, wherein the animal food is free of canola oil.

10. The hypoallergenic animal food according to claim 1, wherein the animal food is free of citric acid and canola oil.

11. The hypoallergenic animal food according to claim 1, further comprising at least one or more ingredients selected from the group consisting of DHA, ARA, EPA, glucosamine, chondroitin and MSM.

12. A hypoallergenic animal food comprising:
a lipid comprising olive oil;
an agglomerating agent;
a carbohydrate; and
a preservative that comprises d-alpha Tocopherol.

13. A hypoallergenic animal food comprising:
a lipid that comprises olive oil;
an agglomerating agent that comprises molasses;
a carbohydrate that comprises oat flour; and
a preservative that comprises d-alpha Tocopherol.

14. A hypoallergenic animal food comprising:
a lipid that comprises olive oil;
an agglomerating agent that comprises molasses;
a carbohydrate that comprises a mixture of potato flour and potato starch flour; and
a preservative that comprises a mixture of a buffering agent and d-alpha Tocopherol.

15. A hypoallergenic animal food comprising:
a lipid that comprises duck fat;
an agglomerating agent that comprises molasses;
a carbohydrate that comprises a mixture of potato flour and potato starch flour;
a preservative that comprises a mixture of a buffering agent and d-alpha Tocopherol; and
rosemary extract.

16. A method of providing food to an animal comprising administering to the animal the hypoallergenic animal food of claim 1.

17. An article of manufacture comprising a package containing the hypoallergenic animal food of claim 1.
